(19) United States
(12) Patent Application Publication
(10) Pub. No.: US 2019/0236462 A1
(43) Pub. Date: Aug. 1, 2019

(54) SYSTEM AND METHOD FOR PREDICTING FUTURE NEWS COVERAGE

(71) Applicants: Kellen Davison, Toronto (CA); Jenny-Leanne Davison, Toronto (CA)

(72) Inventors: Kellen Davison, Toronto (CA); Jenny-Leanne Davison, Toronto (CA)

(21) Appl. No.: 15/886,746

(22) Filed: Feb. 1, 2018

(51) Int. Cl. G06N 5/04; G06N 5/02; G06F 15/18; G06F 17/28; G06Q 30/02

(52) U.S. Cl. CPC G06N 5/04; G06N 5/025; G06Q 30/0202; G06F 17/28; G06F 15/18

(57) ABSTRACT

A computer-implemented system and method for predicting and assessing future publicity of an organization or individual including receiving a potential future sentiment value of the company determined from a data set of a plurality of current and prior news sources with sentiment values and then, utilizing a processing circuit connected to the database, where potential future written communication documents including a press release, speech, marketing brochure, blog, or ghost-written article are added to the initial database, determining at least one potential future news story for the company utilizing a predictive analysis algorithm.

### BACKGROUND OF THE INVENTION

### 1. Field of Invention

The present invention relates generally to public relations and in particular to a method and system for predicting future news stories and sentiment in response to potential information.

### 2. Description of Related Art

In many industries there is a need for individuals and organizations to determine the sentiment or feelings and attitude of the public to current events activities of the companies. Traditionally, determining the perception of the company has been a time-consuming activity requiring focus groups, research and analysis.

With the growth of machine learning or artificial intelligence, these tasks have been greatly accelerated and simplified. Examples of such systems may be illustrated, for example in US Patent Application Publication No. US2013/0138577 to Sisk. However, the results of these types of analysis has been limited to providing only a summary of the current sentiment or perception of the company based on past and current events, news releases or articles. It will be appreciated that such predictions systems do not enable a company or organization to predict future news stories. Nor does system provide any further guidance to the company as to best steps to guide or form the future public sentiment.

### SUMMARY OF THE INVENTION

According to a first embodiment of the present invention there is disclosed a computer-implemented method for predicting and assessing future publicity of a company comprising receiving a current sentiment value of the company determined from a plurality of current and prior information sources, inputting the current sentiment value of the company into a database and utilizing a processing circuit operably connected to the database, determining at least one potential future news story for the company utilizing a predictive analysis algorithm.

The step of receiving a current sentiment value of the company may comprise receiving a plurality of current and prior information sources, inputting the plurality of current and prior information sources into the database and utilizing a processing circuit operably connected to the database, determining the current sentiment value utilizing a sentiment analysis algorithm.

The method may further comprise receiving and inputting at least one potential future information source into the database prior to determining the at least one potential future new story. The sentiment analysis algorithm may comprise an artificial intelligence (AI) natural language processing (NLP), and machine learning knowledge system. The predictive analysis algorithm may comprise an artificial intelligence (AI) natural language processing (NLP), and machine learning knowledge system. The sentiment analysis algorithm and the predictive analysis algorithm may be substantially the same.

According to a further embodiment of the present invention there is disclosed a system for predicting and assessing future publicity of a company comprising a database configured to receive a current sentiment value of the company determined from a plurality of current and prior information sources and a plurality of potential future information sources into the database and a processing circuit operably connected to the database being operable to determine at least one potential future news story for the company utilizing a predictive analysis algorithm.

The database may further include a plurality of current and prior information sources and a plurality of current and prior information sources into the database and the processing circuit is further configured to determine the current sentiment value utilizing a sentiment analysis algorithm.

The system may further comprise receiving and inputting at least one potential future information source into the database prior to determining the at least one potential future new story.

The sentiment analysis algorithm may comprise an artificial intelligence (AI) natural language processing (NLP), and machine learning knowledge system. The predictive analysis algorithm may comprise an artificial intelligence (AI) natural language processing (NLP), and machine learning knowledge system. The sentiment analysis algorithm and the predictive analysis algorithm may be substantially the same.

According to a further embodiment of the present invention, there is disclosed a non-transitory computer useable medium storing a program for predicting and assessing future public opinion of a company which when executed by at least one processing circuit of a computing device to perform the steps of receiving a current sentiment value of the company determined from a plurality of current and prior information sources, inputting the current sentiment value of the company into a database and utilizing a processing circuit operably connected to the database, determining for each of the potential future information sources, a future sentiment value utilizing a predictive analysis algorithm.

The step of receiving a current sentiment value of the company may comprise receiving a plurality of current and prior information sources, inputting the plurality of current and prior information sources into the database and utilizing a processing circuit operably connected to the database, determining the current sentiment value utilizing a sentiment analysis algorithm. The processing circuit may further be adapted to receive at least one potential future information source into the database prior to determining the at least one potential future new story.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a schematic diagram of a system for predicting sentiment of a company in response to a plurality of potential future information sources according to a first embodiment of the present invention.

FIG. 2 is an illustration of the system of FIG. 1.

FIG. 3 is a flowchart diagram of a method for use in the system of FIG. 1.

FIG. 4 is an illustration of an output screen of a plurality of potential news stories for a company.

FIG. 5 is an illustration of an output screen of a plurality of potential news stories for a potential future information source for a company.

### DETAILED DESCRIPTION

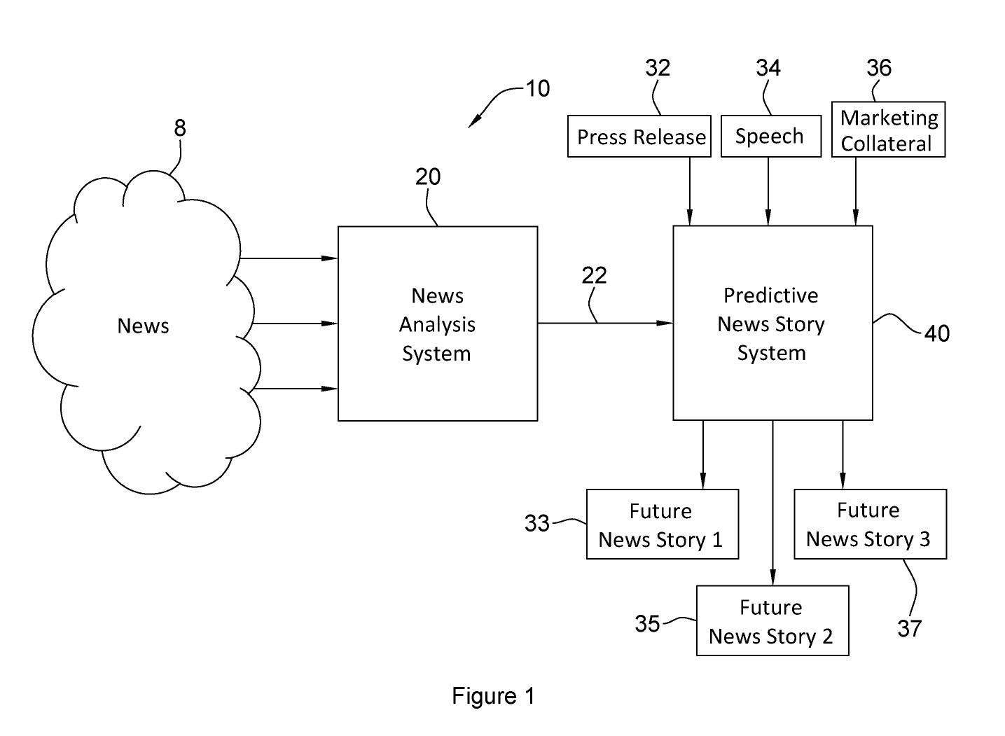

Referring to FIG. 1, a system for predicting at least one future potential news story about a company according to a first embodiment of the invention is shown generally at 10. The system includes a sentiment analysis algorithm system 20 adapted to receive a plurality of current and previous news and information sources. The sentiment analysis algorithm 20 produces a sentiment score 22 to a predictive algorithm system 40 which then uses such sentiment score 22 to predict at least one potential future news story 33, 35 and 37. As illustrated in FIG. 1, the predictive algorithm 40 may optionally receive and utilize at least one potential information source 32, 34 and 36 to predict the potential news story.

Although the entity for which the present method is utilized is described herein as a company, it will be appreciated that such method will also be useful for predicting the future sentiment of any other entity as well such as, by way of non-limiting example, a government, non-profit organization or other organization or individuals including celebrities, athletes or politicians. As utilized herein, the term information source will be understood to include all news stories, including print, video, internet as well as press releases, opinions, speeches, blog articles, ghost-written opinion articles, and various type of marketing collateral including product brochures and financial performance of the company, its competitors, market and the industry in general. It will be appreciated that the information utilized in by the system of the present invention may be gathered in any convention manner. In particular, the information may be selected by an operator and inputted into the system or the system may be operably connected to the internet so as to continuously or intermittently search the internet for articles, opinions, blogs etc. which are about the company through the use of robots and the like, which are commonly known. The sentiment analysis system 20 and predictive sentiment system 40 are configured to utilize artificial intelligence (AI), natural language processing (NLP), and machine learning knowledge system to “read” news stories, press releases and other information sources to analyses the tone, content and implications of such information sources utilizing techniques which are commonly known.

It will be appreciated that the sentimental analysis algorithm 20 and/or predictive algorithm 40 is executed on a computer through a processing circuit as will be more fully set out below. The sentimental analysis algorithm 20 may be the same as or different from the predictive algorithm 40. In particular, the same algorithm and processing circuit may be utilized for each analysis. The sentiment analysis algorithm and predictive algorithm 40 will frequently be located on a server wherein the information provided thereto is inputted at the location of the server or across a network as are commonly known. Optionally, various embodiments may comprise a client-server system architecture where some computing or processing steps occur on a remote user device 60 and some on the processing circuit 42 of the predictive system 40.

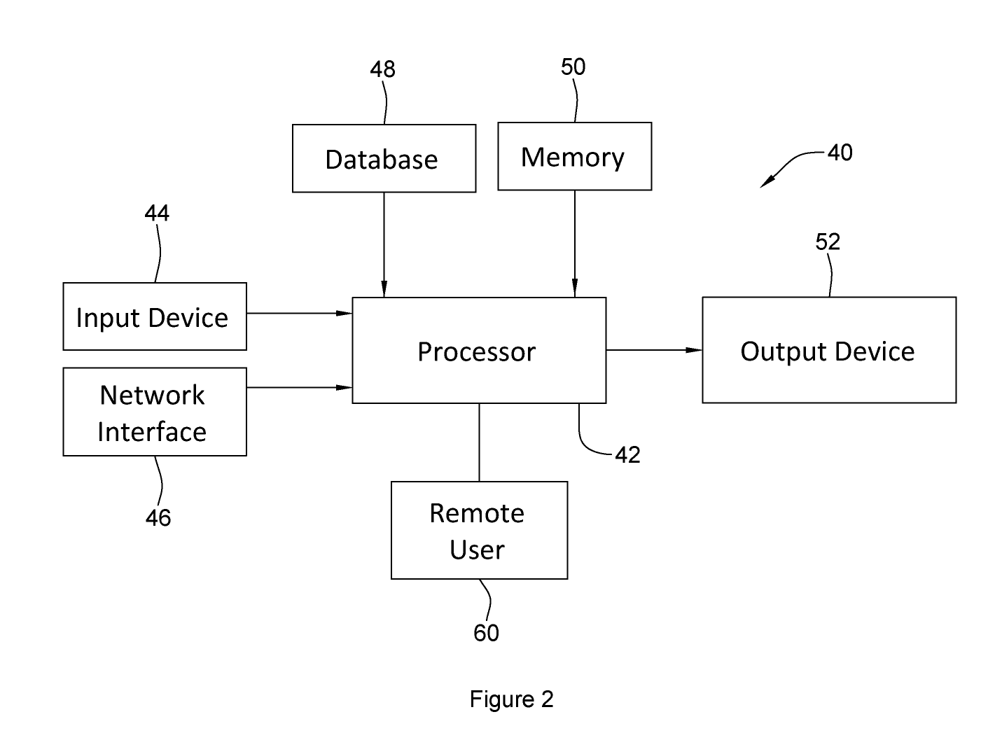

Turning now to FIG. 2, a schematic of the predictive sentiment system 40 is illustrated. As set out above the sentiment analysis system 20 may also be implemented on the predictive system 40 such that a common processor and database are utilized. In particular the predictive sentiment system 40 comprises a processing circuit 42, and memory 50 that stores machine instructions that when executed by the processing circuit 42, cause the processing circuit 42 to perform one or more of the operations and methods described herein. The database 48 may be separate from the processor 42 although it will be appreciated that the database 48 may be contained within and a part of the predictive sentiment system 40. Processing circuit 42 may optionally contain a cache memory unit for temporary local storage of instructions, data, or computer addresses. The processing circuit 42 may optionally include an input device 44 and display 52 or other output device for receiving and displaying inputs from a database manager or user as are commonly known. As illustrated in FIG. 2, the predictive system 40 also includes a network interface 46 such as a radio transmitter, ethernet adapter or the like for providing communication between the processing circuit 42 and the internet to search for and obtain information sources.

More generally, in this specification, including the claims, the term “processing circuit ” is intended to broadly encompass any type of device or combination of devices capable of performing the functions described herein, including (without limitation) other types of microprocessing circuits, microcontrollers, other integrated circuits, other types of circuits or combinations of circuits, logic gates or gate arrays, or programmable devices of any sort, for example, either alone or in combination with other such devices located at the same location or remotely from each other. Additional types of processing circuit(s) will be apparent to those ordinarily skilled in the art upon review of this specification, and substitution of any such other types of processing circuit(s) is considered not to depart from the scope of the present invention as defined by the claims appended hereto. In various embodiments, the processing circuit 42 can be implemented as a single-chip, multiple chips and/or other electrical components including one or more integrated circuits and printed circuit boards.

Computer code comprising instructions for the processing circuit(s) to carry out the various embodiments, aspects, features, etc. of the present disclosure may reside in the memory 50. In various embodiments, the processing circuit 42 can be implemented as a single-chip, multiple chips and/or other electrical components including one or more integrated circuits and printed circuit boards. The processing circuit 42 together with a suitable operating system may operate to execute instructions in the form of computer code and produce and use data. By way of example and not by way of limitation, the operating system may be Windows-based, Mac-based, or Unix or Linux-based, among other suitable operating systems. Operating systems are generally well known and will not be described in further detail here.

Memory 50 may include various tangible, non-transitory computer-readable media including Read-Only Memory (ROM) and/or Random-Access Memory (RAM). As is well known in the art, ROM acts to transfer data and instructions uni-directionally to the processing circuit 42, and RAM is used typically to transfer data and instructions in a bi-directional manner. In the various embodiments disclosed herein, RAM includes computer program instructions that when executed by the processing circuit 42 cause the processing circuit 42 to execute the program instructions described in greater detail below. More generally, the term “memory” as used herein encompasses one or more storage mediums and generally provides a place to store computer code (e.g., software and/or firmware) and data that are used by the predictive sentiment system 40. It may comprise, for example, electronic, optical, magnetic, or any other storage or transmission device capable of providing the processing circuit 42 with program instructions. Memory 50 may further include a floppy disk, CD-ROM, DVD, magnetic disk, memory chip, ASIC, FPGA, EEPROM, EPROM, flash memory, optical media, or any other suitable memory from which processing circuit 42 can read instructions in computer programming languages.

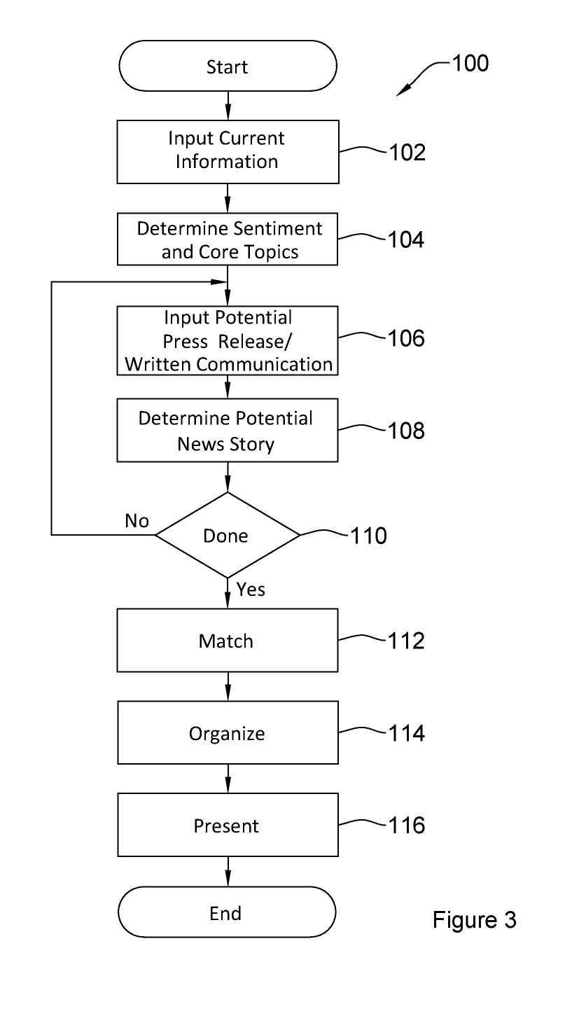

FIG. 3 is a flowchart depicting the actions during the method 100 taken on predictive sentiment system 40. In step 102, the processing circuit receives the information through the input device 44 or through the internet connection 46. Thereafter in step 104, the predictive sentiment system 40 determines the current sentiment scores for the company. It will be appreciated that the sentiment score for the company may be represented by a single or a plurality of values as are commonly known. In particular the sentiment score may comprise any commonly known collection of data representing tone, keywords, articles, topics and sources of the current news stories related to the company. It will be appreciated that such data may be selected to include as many reporters, publications or fields as desired by a user.

This current sentiment score for the company is then stored within the database 48. In step 106, the predictive system 40 may optionally receive a plurality of potential future information sources and then determines a plurality of potential future news stories in step 108 utilizing either the current sentiment score alone or the current sentiment score in combination with the possible information source. As illustrated in FIG. 110, the predictive system 40 continues preparing predicted future potential news stories until all potential future information sources has been processed at which point the predicted future sentiment score for each potential information source is then matched to its corresponding potential information source in step 112. The potential future information may then optionally be organized for presentation to a user in steps 114 and 116 in any desired ranking such as in order of potential information sources most likely to provide the most positive future news stories.

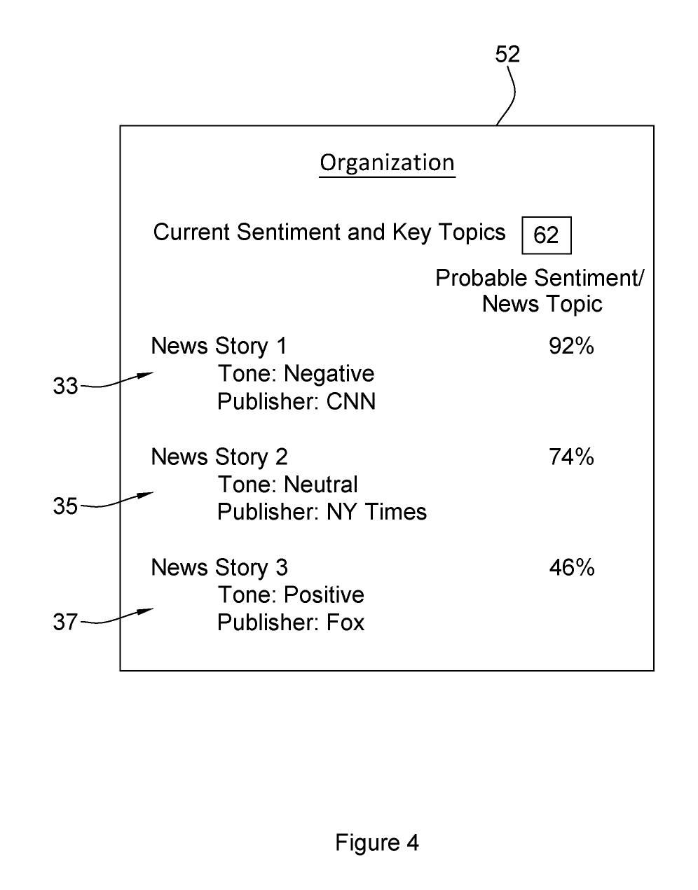

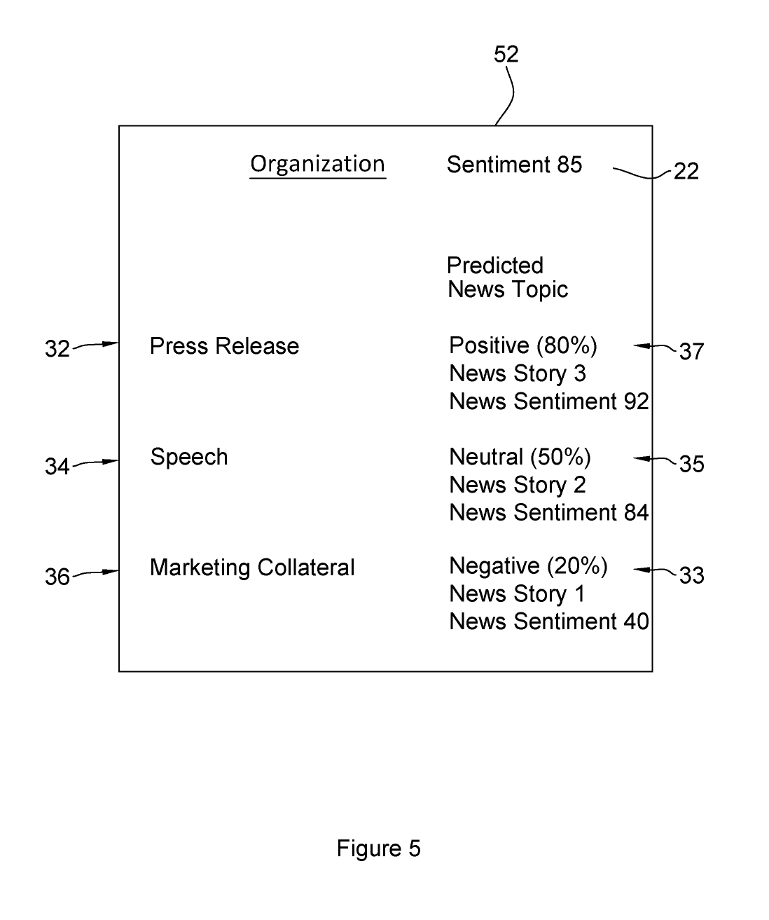

Turning now to FIGS. 4 and 5, the output device 52 may be adapted to present the results of the above analysis to the user in any manner desired. In particular, as illustrated in FIG. 4, one or more potential future news stories 33, 35 and 37 may be illustrated based upon the current sentiment score alone. The potential future news stories listed may include any details such as, author, publication, keywords, sentiment, tone, possible sentiment score change to the company or any other information as desired by a user. The output may also display a probability for each news story, 72, 74 and 76, respectively. It will be appreciated that the content forming the potential news story may be comprised of a plurality of criteria wherein the output device may provide the current score 78 in each category as well as the probability of such predicted news story. It will be appreciated that an updated sentiment score may then be calculated by the system to determine the effect of the potential news story on the company's reputation.

Alternatively, as illustrated in FIG. 5, the output device 52 may be adapted to provide an organized summary of a plurality of potential future news stories 33, 35 and 37 for each of at least one potential press release 32, 34 and 36 issued by the company. It will be appreciated that such comparative analysis will permit a company to test a plurality of potential news stories to determine the optimal language that may be used to provide the best effect on the public sentiment of the company, either as an overall score or as a particular category. As illustrated in FIG. 5, the current sentiment score 22 may be presented along with the ranked potential future news stories along with their associated predicted future sentiment score.

While specific embodiments of the invention have been described and illustrated, such embodiments should be considered illustrative of the invention only and not as limiting the invention as construed in accordance with the accompanying claims.

What is claimed is:

1. A computer-implemented method for predicting and assessing future publicity of a company comprising:
receiving a current sentiment value of said company determined from a plurality of current and prior information sources;
inputting said current sentiment value of said company into a database; and
utilizing a processing circuit operably connected to said database, determining at least one potential future news story for said company utilizing a predictive analysis algorithm.

2. The method of claim 1 wherein said receiving a current sentiment value of said company comprises:
receiving a plurality of current and prior information sources;
inputting said plurality of current and prior information sources into said database; and
utilizing a processing circuit operably connected to said database, determining said current sentiment value utilizing a sentiment analysis algorithm.

3. The method of claim 2 further comprising receiving and inputting at least one potential future information source into said database prior to determining said at least one potential future new story.

4. The method of claim 2 wherein said sentiment analysis algorithm comprises an artificial intelligence (AI) natural language processing (NLP), and machine learning knowledge system.

5. The method of claim 3 wherein said predictive analysis algorithm comprises an artificial intelligence (AI) natural language processing (NLP), and machine learning knowledge system.

6. The method of claim 3 wherein said sentiment analysis algorithm and said predictive analysis algorithm are substantially the same.

7. A system for predicting and assessing future publicity of a company comprising:
a database configured to receive a current sentiment value of said company determined from a plurality of current and prior information sources and a plurality of potential future information sources into said database; and
a processing circuit operably connected to said database being operable to determine at least one potential future news story for said company utilizing a predictive analysis algorithm.

8. The system of claim 7 wherein:
said database further includes a plurality of current and prior information sources and a plurality of current and prior information sources into said database; and
wherein said processing circuit is further configured to determine said current sentiment value utilizing a sentiment analysis algorithm.

9. The system of claim 8 further comprising receiving and inputting at least one potential future information source into said database prior to determining said at least one potential future new story.

10. The system of claim 9 wherein said sentiment analysis algorithm comprises an artificial intelligence (AI) natural language processing (NLP), and machine learning knowledge system.

11. The system of claim 9 wherein said predictive analysis algorithm comprises an artificial intelligence (AI) natural language processing (NLP), and machine learning knowledge system.

12. The system of claim 9 wherein said sentiment analysis algorithm and said predictive analysis algorithm are substantially the same.

13. A non-transitory computer useable medium storing a program for predicting and assessing future public opinion of a company which when executed by at least one processing circuit of a computing device to perform the steps of:
receiving a current sentiment value of said company determined from a plurality of current and prior information sources;
inputting said current sentiment value of said company into a database; and
utilizing a processing circuit operably connected to said database, determining for each of said potential future information sources, a future sentiment value utilizing a predictive analysis algorithm.

14. The non-transitory computer useable medium of claim 17 wherein said the step of receiving a current sentiment value of said company comprises:
receiving a plurality of current and prior information sources;
inputting said plurality of current and prior information sources into said database; and
utilizing a processing circuit operably connected to said database, determining said current sentiment value utilizing a sentiment analysis algorithm.

15. The non-transitory computer useable medium of claim 14 wherein said processing circuit is further adapted to receive at least one potential future information source into said database prior to determining said at least one potential future new story.
